(19) United States
(12) Patent Application Publication
(10) Pub. No.: US 2011/0223844 A1
(43) Pub. Date: Sep. 15, 2011

(54) POLISHING PAD AND METHOD FOR MAKING THE SAME

(75) Inventors: CHUNG-CHIH FENG, KAOHSIUNG (TW); KUN-CHENG TSAI, KAOHSIUNG (TW); YUNG-CHANG HUNG, KAOHSIUNG (TW); I-PENG YAO, KAOHSIUNG (TW)

(73) Assignee: SAN FANG CHEMICAL INDUSTRY CO., LTD., Kaohsiung (TW)

(21) Appl. No.: 12/777,159

(22) Filed: May 10, 2010

(30) Foreign Application Priority Data
Mar. 10, 2010 (TW) 099106972

(51) Int. Cl. B24D 11/00; B05D 3/10; B05D 3/02

(52) U.S. Cl. 451/532; 427/340

(57) ABSTRACT

The present invention relates to a polishing pad and method for making the same. The polishing pad comprises a plurality of fibers and a high polymeric elastomer compound. The fibers cross each other to form a fabric substrate. The high polymeric elastomer compound includes a first high polymeric elastomer resin and a second high polymeric elastomer resin. The weight-average molecular weight of the first high polymeric elastomer resin is 100,000 to 300,000. The second high polymeric elastomer resin is a two-component high polymeric elastomer resin, and includes a first component and a second component. The first component is polyol with a molecular weight of 1,500 to 2,500 and 1 wt % to 15 wt %. The second component is polyol with a molecular weight of 3,500 to 4,500 and 85 wt % to 99 wt %. Therefore, the polishing pad has better stiffness, a plurality of communicating holes and active fibers, so that a workpiece to be polished will have excellent surface quality.

### BACKGROUND OF THE INVENTION

1. Field of the Invention

The present invention relates to a polishing pad and method for making the same, and more particularly to a polishing pad having a plurality of communicating holes and method for making the same.

2. Description of the Related Art

FIG. 1 shows a schematic cross-sectional view of a first conventional polishing pad disclosed by Taiwan (R.O.C.) Patent Publication No. 200641193. The polishing pad 1 is a non-woven polishing pad, which includes a plurality of fibers 12 and a resin 14. The polishing pad 1 is manufactured by using a composite material of the fibers 12 and the resin 14 such as velvet or suede, or a flexible sheet having high deformability formed by impregnating a non-woven fabric formed by the fibers 12 in a thermoplastic polyurethane resin 14 for wet coagulation. A disadvantage of the polishing pad 1 is that the flexibility thereof may easily lead to poor planarization performance of its abrasive surface, and the resin 14 cannot uniformly enclose the fibers 12, that is, a portion of the fibers 12 is not enclosed by the resin 14.

FIG. 2 shows a schematic cross-sectional view of a second conventional polishing pad disclosed by Taiwan (R.O.C.) Patent No. 528646. The polishing pad 2 is a separate foam polishing pad which includes a plurality of holes 22 and a resin 24. The polishing pad 2 is manufactured by pouring the resin 24 (generally a high polymeric foam of thermoplastic polyurethane) into a cylindrical mold, cooling the resin 24 for coagulation, and then slicing the resin 24. The polishing pad 2 has higher stiffness than the first conventional polishing pad 1 (FIG. 1), has separate pore structures, and is usually used for high planarization polishing. However, the major problem of the polishing pad 2 is that since it is difficult to achieve uniform distribution of the concentration of the resin 24 in the cylindrical mold, non-uniform temperature distribution at positions in the cylindrical mold during the molding process may lead to different sizes and non-uniform distribution of the holes 22, and as a result, after the slicing process, the difference between the sizes of the holes 22 on the sliced surface of the polishing pad 2 becomes more significant. Moreover, the holes 22 are not in communication with each other, and the abrasive slurry may not easily flow therebetween.

Therefore, it is necessary to provide an innovative and inventive polishing pad and method for making the same.

### SUMMARY OF THE INVENTION

The present invention provides a polishing pad, which comprises a plurality of fibers and a high polymeric elastomer compound. The fibers cross each other to form a fabric substrate. The high polymeric elastomer compound is formed by combining a first high polymeric elastomer resin with a second high polymeric elastomer resin. The weight-average molecular weight of the first high polymeric elastomer resin is 100,000 to 300,000. The second high polymeric elastomer resin is a two-component high polymeric elastomer resin, and comprises a first component and a second component. The first component is polyol with a molecular weight of 1,500 to 2,500 and 1 wt % to 15 wt %, the second component is polyol with a molecular weight of 3,500 to 4,500 and 85 wt % to 99 wt %. The high polymeric elastomer compound encloses the fibers and has a plurality of holes, and the holes are in communication with each other.

The present invention further provides a method for making a polishing pad, comprising the following steps: (a) providing a fabric substrate; (b) placing the fabric substrate into a first high polymeric elastomer resin solution, and repeatedly pressing and releasing the fabric substrate so that the first high polymeric elastomer resin solution infiltrates the fabric substrate due to pressure difference, wherein the first high polymeric elastomer resin solution comprises a first high polymeric elastomer resin, and the weight-average molecular weight of the first high polymeric elastomer resin is 100,000 to 300,000; (c) coagulating the first high polymeric elastomer resin solution infiltrating the fabric substrate; (d) performing a high-pressure rinsing process; (e) performing a heating process so as to form a semi-finished polishing pad; (f) placing the semi-finished polishing pad in a second high polymeric elastomer resin solution, wherein the second high polymeric elastomer resin solution comprises a second high polymeric elastomer resin, the second high polymeric elastomer resin is a two-component high polymeric elastomer resin and comprises a first component and a second component, the first component is polyol with a molecular weight of 1,500 to 2,500 and 1 wt % to 15 wt %, the second component is polyol with a molecular weight of 3,500 to 4,500 and 85 wt % to 99 wt %, and the second high polymeric elastomer resin and the first high polymeric elastomer resin are combined into a high polymeric elastomer compound; and (g) performing a heating process so as to form a polishing pad.

In the present invention, the polishing pad has better stiffness, high planarization performance, a plurality of communicating holes and active fibers, so that a workpiece to be polished will have an excellent surface quality. Moreover, the manufacturing method of the polishing pad can ensure better stability and reproducibility.

### BRIEF DESCRIPTION OF THE DRAWINGS

FIG. 1 is a schematic cross-sectional view of a first conventional polishing pad disclosed by Taiwan (R.O.C.) Patent Publication No. 200641193;

FIG. 2 is a schematic cross-sectional view of a second conventional polishing pad disclosed by Taiwan (R.O.C.) Patent No. 528646; and

FIG. 3 is a schematic cross-sectional view of a polishing pad according to the present invention.

### DETAILED DESCRIPTION OF THE INVENTION

The present invention relates to a method for making a polishing pad, which includes the following steps. First, a fabric substrate is provided. In an embodiment, the fabric substrate is a non-woven fabric, and is formed by a plurality of fibers crossing each other. The material of the fibers is selected from a group consisting of polyamide resin, polyethylene terephthalate (PET), nylon, polypropylene (PP), polyester resin, acrylic resin, polyacrylonitrile resin, and composites thereof. Preferably, the fibers are composite fibers, which include 50 wt % to 90 wt % of nylon and 10 wt % to 50 wt % of PET.

Then, the fabric substrate is placed into a first high polymeric elastomer resin solution, and a device capable of generating different pressures is used to repeatedly press and release the fabric substrate, so that the first high polymeric elastomer resin solution infiltrates the fabric substrate due to pressure difference. The first high polymeric elastomer resin solution contains a first high polymeric elastomer resin. In an embodiment, the first high polymeric elastomer resin solution further contains a dimethylformamide (DMF) solvent and a surfactant. Of the total weight of the first high polymeric elastomer resin solution, the first high polymeric elastomer resin is 40 wt % to 55 wt %, the DMF solvent is 40 wt % to 55 wt %, and the surfactant is 0.1 wt % to 5 wt %. The first high polymeric elastomer resin is selected from a group consisting of polyamide resin, polycarbonate, polymethacrylic resin, epoxy resin, phenol resin, polyurethane resin, vinylbenzene resin, and acrylic resin.

Then, the first high polymeric elastomer resin solution infiltrating the fabric substrate coagulates. In an embodiment, in this step, the fabric substrate and the first high polymeric elastomer resin solution infiltrating the fabric substrate are placed into an aqueous DMF solution in a coagulation bath for coagulation, so as to permit coagulation and replacement of the first high polymeric elastomer resin solution infiltrating the fabric substrate with the aqueous DMF solution. The aqueous DMF solution contains water and DMF, and DMF is 15 wt % to 35 wt % of the total weight of the aqueous DMF solution.

Then, a high-pressure rinsing process is performed. In an embodiment, in this step, at least one device capable of generating different pressures is used in a rinsing bath to perform a inhaling and exhaling process by continuous extrusion, so as to wash away impurities, the used solvent, and the surfactant infiltrating the fabric substrate through high temperature and pressure difference.

Then, a heating process is performed, so as to form a semi-finished polishing pad. In an embodiment, in this step, the heating process is performed at 100° C. to 200° C., so as to dry the fabric substrate and the first high polymeric elastomer resin solution infiltrating the fabric substrate by evaporation. Preferably, after this step, the method further includes a step of dressing a surface of the semi-finished polishing pad.

Then, the semi-finished polishing pad is placed in a second high polymeric elastomer resin solution. The second high polymeric elastomer resin solution contains a second high polymeric elastomer resin. The second high polymeric elastomer resin is a two-component high polymeric elastomer resin, and includes a first component and a second component.

The first component is polyol with a molecular weight of 1,500 to 2,500 and 1 wt % to 15 wt %. The second component is polyol with a molecular weight of 3,500 to 4,500 and 85 wt % to 99 wt %. The second high polymeric elastomer resin and the first high polymeric elastomer resin are combined into a high polymeric elastomer compound. Preferably, the first component has a molecular weight of 2,000 and is 5 wt %, and the second component has a molecular weight of 4,000 and is 95 wt %.

In an embodiment, the second high polymeric elastomer resin solution further contains a solvent, a filler, and a surfactant. Of the total weight of the second high polymeric elastomer resin solution, the second high polymeric elastomer resin is 30 wt % to 40 wt %, the solvent is 40 wt % to 50 wt %, the filler is 5 wt % to 25 wt %, and the surfactant is 0.1 wt % to 5 wt %. The solvent is selected from the group consisting of DMF, toluene, cyclohexanone, methyl ethyl ketone, and mixtures thereof. The polyol is a thermoplastic resin, a thermosetting resin, or a mixture thereof. The thermoplastic resin comprises a high polymeric diol, an organic diisocyanate, and a chain extender. The high polymeric diol is selected from a group consisting of polyolefin, polystyrene, polyacrylate, acrylonitrile-styrene-butadiene copolymer, acrylate, vinyl ester, saturated polyester, polyamide, polyvinylidene fluoride, polycarbonate, polyformaldehyde resins and polyurethane. The thermosetting resin is selected from a group consisting of urethane, epoxy, acrylic, unsaturated polyester, polyurethane-urea, urea, silicone, and phenolic resins.

Finally, a heating process is performed, so as to form a polishing pad. In an embodiment, the semi-finished polishing pad in the solution containing the second high polymeric elastomer resin is delivered into a high-temperature heating apparatus, so as to dry the semi-finished polishing pad by evaporating excessive solvent in the second high polymeric elastomer resin solution. Preferably, after this step, the method further comprises a surface dressing step.

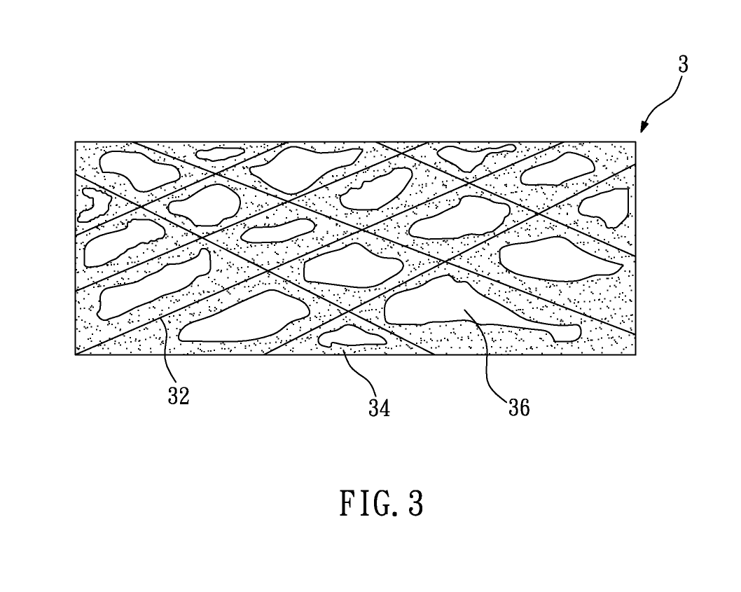

FIG. 3 shows a schematic cross-sectional view of a polishing pad according to the present invention. The polishing pad 3 comprises a plurality of fibers 32 and a high polymeric elastomer compound 34. The fibers 32 cross each other to form a fabric substrate. In an embodiment, the fabric substrate is a non-woven fabric. The material of the fibers 32 is selected from a group consisting of polyamide resin, PET, nylon, PP, polyester resin, acrylic resin, polyacrylonitrile resin, and composites thereof. Preferably, the fibers 32 are composite fibers, which comprise 50 wt % to 90 wt % of nylon and 10 wt % to 50 wt % of PET.

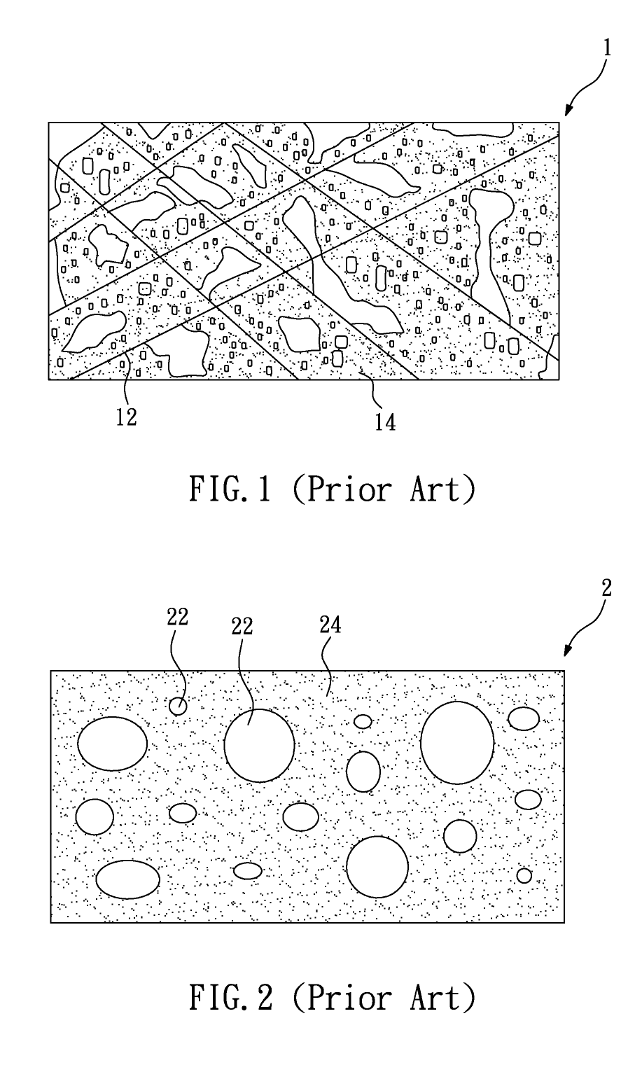

The high polymeric elastomer compound 34 is formed by combining a first high polymeric elastomer resin with a second high polymeric elastomer resin. The high polymeric elastomer compound 34 encloses the fibers 32 and has a plurality of holes 36, and the holes 36 are in communication with each other. Preferably, the fibers 32 are completely enclosed by the high polymeric elastomer compound 34, that is, the situation shown in FIG. 1 wherein a portion of the fibers 12 is not enclosed by the resin 14 will not occur. Moreover, the size of the holes 36 is uniform and easy to control, and all the holes 36 are in communication.

The first high polymeric elastomer resin has a weight-average molecular weight of 100,000 to 300,000. The second high polymeric elastomer resin is a two-component high polymeric elastomer resin, and comprises a first component and a second component. The first component is polyol with a molecular weight of 1,500 to 2,500 and 1 wt % to 15 wt %. The second component is polyol with a molecular weight of 3,500 to 4,500 and 85 wt % to 99 wt %. Preferably, the first component has a molecular weight of 2,000 and is 5 wt %, and the second component has a molecular weight of 4,000 and is 95 wt %.

The first high polymeric elastomer resin is selected from a group consisting of polyamide resin, polycarbonate, polymethacrylic resin, epoxy resin, phenol resin, polyurethane resin, vinylbenzene resin, and acrylic resin.

The polyol is a thermoplastic resin, a thermosetting resin, or a mixture thereof. The thermoplastic resin comprises a high polymeric diol, an organic diisocyanate, and a chain extender. The high polymeric diol is selected from a group consisting of polyolefin, polystyrene, polyacrylate, acrylonitrile-styrene-butadiene copolymer, acrylate, vinyl ester, saturated polyester, polyamide, polyvinylidene fluoride, polycarbonate, polyformaldehyde resins and polyurethane. The thermosetting resin is selected from a group consisting of urethane, epoxy, acrylic, unsaturated polyester, polyurethane-urea, urea, silicone, and phenolic resins.

Preferably, the first high polymeric elastomer resin is a polyamide resin, and the polyol is polyurethane.

Examples are given below to illustrate the present invention, but the present invention is not limited thereto.

### Example 1

First, composite fibers with a fineness of 3 den (70 wt % of nylon and 30% of PET) are bundled together to form a fabric substrate. The fabric substrate is a non-woven fabric (i.e., non-woven base fabric), and the non-woven fabric has a thickness of 2.25 mm, a density of 0.22 g/cm³, and a weight of 496 g/m².

Then, the non-woven fabric is placed in a first high polymeric elastomer resin solution, and a device capable of generating different pressures is used to repeatedly press and release the non-woven fabric, so that the first high polymeric elastomer resin solution infiltrates the non-woven fabric due to pressure difference. The first high polymeric elastomer resin solution is mainly composed of a polyamide resin (the first high polymeric elastomer resin), a DMF solvent, and a surfactant. Of the total weight of the first high polymeric elastomer resin solution, the polyamide resin is 50 wt %, the DMF solvent is 49.5 wt %, and the surfactant is 0.5 wt %.

Then, the non-woven fabric is placed in a coagulation water bath, in which the coagulation water bath contains an aqueous solution containing 25% of DMF prepared by water and DMF, so as to permit coagulation and replacement of the first high polymeric elastomer resin solution infiltrating the non-woven fabric with the aqueous DMF solution.

Afterward, a high-pressure rinsing process is performed, so as to wash away impurities, the DMF solvent, and the surfactant infiltrating the non-woven fabric by continuous extrusion (air pressure=4.0 kg) of an extrusion wheel at a high temperature (80° C.).

After the high-pressure rinsing process is performed, the non-woven fabric is delivered into a high-temperature heating apparatus (140° C.) and dried by water evaporation.

Then, a surface is dressed by a mechanical dressing machine using 150 mesh and 400 mesh sand paper at rates of revolution of 1,200 and 1,300 rpm under a load current of 28 A, so as to obtain a semi-finished polishing pad with a thickness of 1.35 mm.

The semi-finished polishing pad is placed in a second high polymeric elastomer resin solution. The second high polymeric elastomer resin solution contains a second high polymeric elastomer resin, a DMF solvent, methyl ethyl ketone, a filler, and a surfactant.

The second high polymeric elastomer resin is a two-component high polymeric elastomer resin, and comprises a first component and a second component. The first component is polyol with a molecular weight of 2,000 and 5 wt %. The second component is polyol with a molecular weight of 4,000 and 95 wt %. The second high polymeric elastomer resin and the first high polymeric elastomer resin are combined into a high polymeric elastomer compound. The polyol is polyurethane.

Of the total weight of the second high polymeric elastomer resin solution, the second high polymeric elastomer resin is 40 wt %, the DMF solvent is 25 wt %, methyl ethyl ketone is 25 wt %, the filler is 9.5 wt %, and the surfactant is 0.5 wt %.

Then, the semi-finished polishing pad is delivered into a high-temperature heating apparatus (130° C.), so as to dry the semi-finished polishing pad by evaporating excessive solvent in the second high polymeric elastomer resin solution.

Finally, the surface of the semi-finished polishing pad is dressed by a mechanical dressing machine using 150 mesh and 400 mesh sand paper at rates of revolution of 1,200 and 1,300 rpm under a load current of 28 A, so as to obtain a finished polishing pad with a thickness of 1.30 mm.

The present invention has the following advantages. The polishing pad 3 of the present invention has better stiffness, high planarization performance, a plurality of communicating holes 36 and active fibers 32, so that a workpiece to be polished will have an excellent surface quality. Moreover, the manufacturing method of the polishing pad 3 ensures better stability and reproducibility. The first conventional polishing pad 1 (FIG. 1), the second conventional polishing pad 2 (FIG. 2), and the polishing pad 3 of the present invention (FIG. 3) are compared in the following table.

| | First | Second | Polishing pad 3 |
|---|---|---|---|
| | conventional | conventional | of the present |
| Item | polishing pad 1 | polishing pad 2 | invention |
| Hardness | Low | High | High |
| (shore-A) | | | |
| Compression | Poor | Excellent | Excellent |
| ratio (%) | | | |
| Holes | Communicating | Not | Communicating |
| | | communicating | |
| High planariza- | Poor | Good | Good |
| tion polishing | | | |
| performance | | | |
| Service life | Short | Long | Long |
| Process stability | High | Low | High |
| Production | High | Low | High |
| efficiency | | | |

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A polishing pad, comprising:
a plurality of fibers crossing each other to form a fabric substrate; and
a high polymeric elastomer compound formed by combining a first high polymeric elastomer resin with a second high polymeric elastomer resin, wherein the weight-average molecular weight of the first high polymeric elastomer resin is 100,000 to 300,000, the second high polymeric elastomer resin is a two-component high polymeric elastomer resin and comprises a first component and a second component, the first component is polyol with a molecular weight of 1,500 to 2,500 and 1 wt % to 15 wt %, the second component is polyol with a molecular weight of 3,500 to 4,500 and 85 wt % to 99 wt %, the high polymeric elastomer compound encloses the fibers and has a plurality of holes, and the holes are in communication with each other.

2. The polishing pad according to claim 1, wherein the first component has a molecular weight of 2,000 and is 5 wt %, and the second component has a molecular weight of 4,000 and is 95 wt %.

3. The polishing pad according to claim 1, wherein the first high polymeric elastomer resin is selected from a group consisting of polyamide resin, polycarbonate, polymethacrylic resin, epoxy resin, phenol resin, polyurethane resin, vinylbenzene resin, and acrylic resin.

4. The polishing pad according to claim 1, wherein the polyol is a thermoplastic resin, a thermosetting resin, or a mixture thereof, the thermoplastic resin comprises a high polymeric diol, an organic diisocyanate, and a chain extender, the high polymeric diol is selected from a group consisting of polyolefin, polystyrene, polyacrylate, acrylonitrile-styrene-butadiene copolymer, acrylate, vinyl ester, saturated polyester, polyamide, polyvinylidene fluoride, polycarbonate, polyformaldehyde resins and polyurethane, and the thermosetting resin is selected from a group consisting of urethane, epoxy, acrylic, unsaturated polyester, polyurethane-urea, urea, silicone, and phenolic resins.

5. The polishing pad according to claim 1, wherein the fabric substrate is a non-woven fabric.

6. The polishing pad according to claim 1, wherein the material of the fibers is selected from a group consisting of polyamide resin, polyethylene terephthalate (PET), nylon, polyproylene (PP), polyester resin, acrylic resin, polyacrylonitrile resin, and composites thereof.

7. The polishing pad according to claim 1, wherein the fibers are composite fibers, which comprise 50 wt % to 90 wt % of nylon and 10 wt % to 50 wt % of PET.

8. The polishing pad according to claim 1, wherein the fibers are completely enclosed by the high polymeric elastomer compound.

9. A method for making a polishing pad, comprising the following steps of:
(a) providing a fabric substrate;
(b) placing the fabric substrate into a first high polymeric elastomer resin solution, repeatedly pressing and releasing the fabric substrate, so that the first high polymeric elastomer resin solution infiltrates the fabric substrate due to pressure difference, wherein the first high polymeric elastomer resin solution comprises a first high polymeric elastomer resin, and the weight-average molecular weight of the first high polymeric elastomer resin is 100,000 to 300,000;
(c) coagulating the first high polymeric elastomer resin solution infiltrating the fabric substrate;
(d) performing a high-pressure rinsing process;
(e) performing a heating process so as to form a semi-finished polishing pad;
(f) placing the semi-finished polishing pad in a second high polymeric elastomer resin solution, wherein the second high polymeric elastomer resin solution comprises a second high polymeric elastomer resin, and the second high polymeric elastomer resin is a two-component high polymeric elastomer resin and comprises a first component and a second component, the first component is polyol with a molecular weight of 1,500 to 2,500 and 1 wt % to 15 wt %, the second component is polyol with a molecular weight of 3,500 to 4,500 and 85 wt % to 99 wt %, and the second high polymeric elastomer resin and the first high polymeric elastomer resin are combined into a high polymeric elastomer compound; and
(g) performing a heating process so as to form a polishing pad.

10. The method according to claim 9, wherein in step (b), the first high polymeric elastomer resin solution further comprises a dimethylformamide (DMF) solvent and a surfactant, the first high polymeric elastomer resin is 40 wt % to 55 wt % of the total weight of the first high polymeric elastomer resin solution, the DMF solvent is 40 wt % to 55 wt % of the total weight of the first high polymeric elastomer resin solution, and the surfactant is 0.1 wt % to 5 wt % of the total weight of the first high polymeric elastomer resin solution.

11. The method according to claim 9, wherein in step (c), the fabric substrate and the first high polymeric elastomer resin solution infiltrating the fabric substrate are placed into an aqueous DMF solution in a coagulation bath for coagulation, so as to permit coagulation and replacement of the first high polymeric elastomer resin solution infiltrating the fabric substrate with the aqueous DMF solution.

12. The method according to claim 9, wherein in step (f), the second high polymeric elastomer resin solution further contains a solvent, a filler, and a surfactant, the second high polymeric elastomer resin is 30 wt % to 40 wt % of the total weight of the second high polymeric elastomer resin solution, the solvent is 40 wt % to 50 wt % of the total weight of the second high polymeric elastomer resin solution, the filler is 5 wt % to 25 wt % of the total weight of the second high polymeric elastomer resin solution, and the surfactant is 0.1 wt % to 5 wt % of the total weight of the second high polymeric elastomer resin solution.

13. The method according to claim 12, wherein the solvent is selected from a group consisting of DMF, toluene, cyclohexanone, methyl ethyl ketone, and mixtures thereof.
